(19) United States
(12) Patent Application Publication
(10) Pub. No.: US 2009/0094534 A1
(43) Pub. Date: Apr. 9, 2009

(54) SERVER APPARATUS AND CONTROL METHOD OF SERVER APPARATUS

(76) Inventor: Shinya MURAI, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/233,136

(22) Filed: Sep. 18, 2008

(30) Foreign Application Priority Data
Oct. 3, 2007 (JP) 2007-260282

(51) Int. Cl. G06F 3/00; G06F 3/048

(52) U.S. Cl. 715/753; 715/765

(57) ABSTRACT

A server apparatus includes a unit for generating image information, a unit for generating a GUI image for designating time, a unit for compressing the image information and GUI image by coding, a storage unit for storing the compressed image information in association with time, a unit for transmitting the image information and GUI image to an information terminal, a unit for receiving operation information indicating a user's operation on the GUI image displayed on the screen of the information terminal, a converting unit for converting the operation information into time, and a unit for reading out image information corresponding to the converted time from the storage unit.

### CROSS-REFERENCE TO RELATED APPLICATIONS

This application is based upon and claims the benefit of priority from prior Japanese Patent Application No. 2007-260282, filed Oct. 3, 2007, the entire contents of which are incorporated herein by reference.

### BACKGROUND OF THE INVENTION

1. Field of the Invention

The present invention relates to a server apparatus and a control method of the server apparatus.

2. Description of the Related Art

Recently, a conference system is widely used in which image information displayed on the display of an information terminal used by a presenter is displayed on the display of an information terminal of each participant connected across a network, thereby allowing the presenter and participants to hold a conference or the like while watching the same image information on the displays of the individual information terminals (e.g., JP-A 2004-280133 (KOKAI)).

In a conference system like this, the displays of information terminals used by a presenter and participants display the same image. Therefore, each participant cannot individually watch past image information displayed on the display of the information terminal during the conference.

This makes it difficult for a participant who joined the conference in the middle or a participant who has temporarily left the conference to individually recognize the contents of the conference while he or she was absent.

In the prior art as described above, the displays of information terminals used by a presenter and participants display the same image, so each participant cannot individually watch past image information displayed on the display of the information terminal during the conference.

On the other hand, to construct a system that allows each participant to individually watch past image information displayed on the display of an information terminal during a conference, the information terminal used by each participant desirably requires no special function, e.g., desirably requires no installation of any dedicated program.

### BRIEF SUMMARY OF THE INVENTION

According to an aspect of the present invention, there is provided a server apparatus which includes a unit (110) for generating image information, a unit (120) for generating a GUI image for designating time, a unit (140) for compressing the image information and GUI image by coding, a storage unit (150) for storing the compressed image information in association with time, a unit (170) for transmitting the image information and GUI image to an information terminal, a unit (170) for receiving operation information indicating a user's operation on the GUI image displayed on the screen of the information terminal, a converting unit (180) for converting the operation information into time, and a unit (160) for reading out image information corresponding to the converted time from the storage unit (150).

### BRIEF DESCRIPTION OF THE SEVERAL VIEWS OF THE DRAWING

FIG. 1 is a block diagram showing the configuration of a conference system according to the first embodiment;

FIG. 2 is a block diagram showing the arrangement of a conference server according to the first embodiment;

FIG. 3 is a view showing an example of a GUI image according to the first embodiment;

FIG. 4 is a flowchart showing the operation of the conference server according to the first embodiment;

FIG. 5 is a flowchart showing the operation of the conference server according to the first embodiment;

FIG. 6 is a flowchart showing the operation of the conference server according to the first embodiment;

FIG. 7 is a block diagram showing the arrangement of a conference server according to the second embodiment; and

FIG. 8 is a view showing an example of a GUI image according to the second embodiment.

### DETAILED DESCRIPTION OF THE INVENTION

Embodiments of the present invention will be explained below.

### First Embodiment

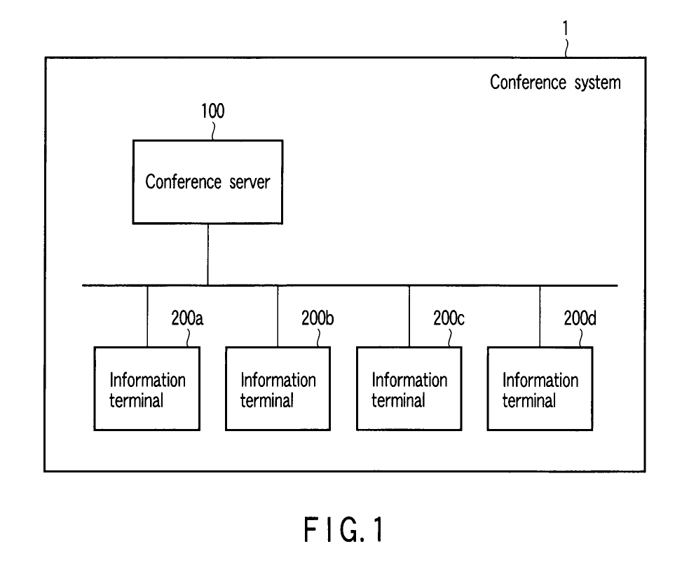

FIG. 1 is a block diagram showing the configuration of a conference system 1 according to the first embodiment.

The conference system 1 according to the first embodiment comprises a conference server 100 and four information terminals 200a to 200d. The conference server 100 and four information terminals 200a to 200d are connected to each other by a network. Users operating the conference server 100 and information terminals 200a to 200d are participants of a conference. The user operating the conference server 100 is a presenter of the conference. In the conference system 1, an image displayed on the display of the conference server 100 is transmitted to the information terminals 200a to 200d, so that the conference server 100 and information terminals 200a to 200d share the image. This allows the participants of the conference to watch the same image on the displays of the conference server 100 and information terminals 200a to 200d operated by these participants.

The conference server 100 is a PC (Personal Computer) capable of executing application programs on an OS (Operating System). The display (not shown) of the conference server 100 displays images such as conference documents and presentation materials.

The conference server 100 sequentially generates images to be displayed on its display and sequentially transmits the images to the information terminals 200a to 200d, thereby displaying the same image on the display of the conference server 100 and the displays of the information terminals 200a to 200d. An image displayed on the displays of the conference server 100 and information terminals 200a to 200d will be called a shared image hereinafter.

To update the whole shared image, the conference server 100 newly generates an image (to be called a whole image hereinafter) corresponding to the whole display region, and transmits the whole image to the information terminals 200a to 200d. To update a part of the shared image, the conference server 100 generates an image (to be called a partial image hereinafter) corresponding to a region to be updated, and position information indicating the update region, and transmits the image and information to the information terminals 200a to 200d.

Note that the conference server 100 is not limited to a PC, and need only be an apparatus for generating images, such as a PDA (Personal Digital (Data) Assistant), cell phone, or game machine. Note also that the conference server 100 need not have any display, and may also be a virtual computer for generating virtual images.

The information terminals 200a to 200d display images received from the conference server 100 on their displays. That is, the information terminals 200a to 200d each display an image received from the conference server 100 on the whole display or in a display area such as a window set in a part of the display.

When receiving a whole image from the conference server 100, the information terminals 200a to 200d each update the whole display area to the new whole image.

When receiving a partial image and position information from the conference server 100, the information terminals 200a to 200d each update a part of the display area designated by the position information to the partial image in the shared image currently being displayed on the display. Note that the information terminals 200a to 200d do not update any image except for the part of the display area designated by the position information.

When operated by the user by using an input device such as a mouse, pen, or keyboard, the information terminals 200a to 200d each generate operation information such as “move the pointer position”, “press the mouse button”, or “input keys”, and transmit the information to the conference server 100 across the network.

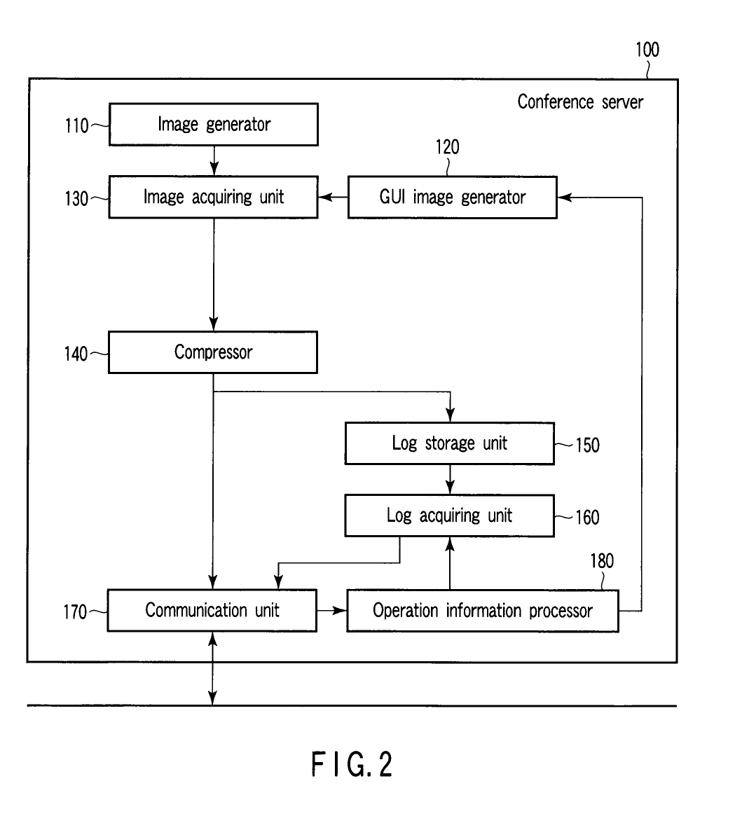

FIG. 2 is a block diagram showing the arrangement of the conference server 100 according to the first embodiment.

The conference server 100 comprises an image generator 110, GUI image generator 120, image acquiring unit 130, compressor 140, log storage unit 150, log acquiring unit 160, communication unit 170, and operation information processor 180.

The image generator 110 generates a whole image or partial image as a shared image to be displayed on the display of the conference server 100 and the displays of the information terminals 200a to 200d. The image generator 110 writes a whole image or partial image of, e.g., the result of execution of an application program in a display frame buffer (not shown). Under the control of the OS, the conference server 100 displays an image on the display by using the whole image or partial image written in the display frame buffer.

The GUI image generator 120 generates a GUI image 10 having an interface for designating time, and an interface for displaying the designated time. The GUI image 10 is transmitted from the conference server 100 to the information terminals 200a to 200d, and displayed on the displays of the information terminals 200a to 200d. The user of any of the information terminals 200a to 200d operates the GUI image 10 displayed on the display, thereby designating the time of a past shared image to be displayed in the display area of the corresponding one of the information terminals 200a to 200d.

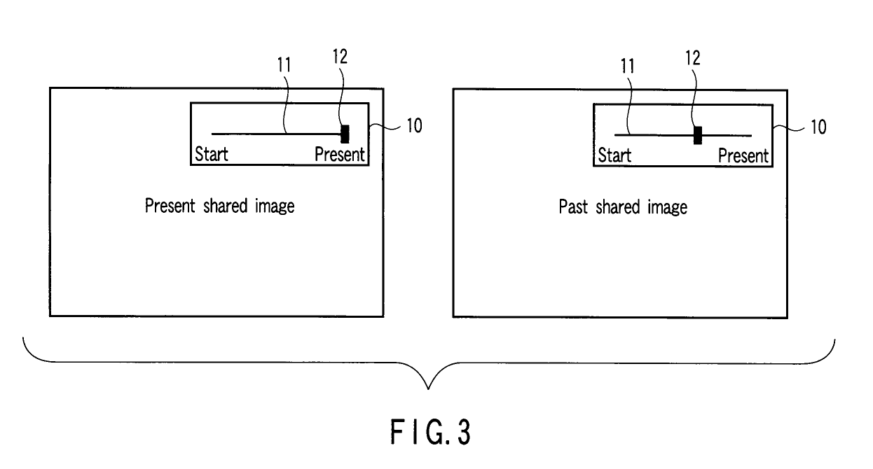

FIG. 3 is a view showing an example of the GUI image 10.

The GUI image 10 has a seek bar 11 from the start point of image sharing to the present point. The user can designate the time immediately after the start of image sharing by setting a slider 12 to the left end of the seek bar 11. For example, the start time of image sharing is the start time of the conference. The user can designate the present time by setting the slider 12 to the right end of the seek bar 11. The user can designate any arbitrary time from the start time of image sharing to the present time by moving the slider 12 along the seek bar 11. The user can visually recognize the designated time by the position of the slider 12.

Note that the displays of the information terminals 200a to 200d display different GUI images 10. For example, if different times are designated in the information terminals 200a to 200d, the positions of the sliders 12 are different on the displays of the information terminals 200a to 200d.

The image acquiring unit 130 acquires a whole image or partial image generated by the image generator 110 by hooking the whole image or partial image written in the display frame buffer. The image acquiring unit 130 acquires the GUI image 10 from the GUI image generator 120.

When acquiring a partial image or the GUI image 10, the image acquiring unit 130 also acquires position information (e.g., the coordinates or block number of the updated region) indicating a region for displaying the partial image or GUI image 10, in addition to the partial image or GUI image 10. Note that the block number is a number given to each block obtained by segmenting the shared image display area into a plurality of areas (blocks).

Note that the image acquiring unit 130 may also receive an update region of the shared image from the image generator 110 executing the OS, and separately acquire a shared image in the update region. The image acquiring unit 130 may also hook a rendering instruction while the image generator 110 executing the OS is generating a shared image to be written in the display frame buffer.

The timing at which the image acquiring unit 130 acquires the shared image or GUI image 10 may be the timing at which the shared image or GUI image 10 is generated by the image generator 110 or GUI image generator 120, or a timing corresponding to a predetermined time interval.

The compressor 140 compresses the whole image or partial image and the GUI image 10 received from the image acquiring unit 130.

The log storage unit 150 associates the compressed whole image or the compressed partial image and its position information with the update time at which the shared image is updated by the whole image or partial image, and stores the result as whole image log information or partial image log information. The whole image log information is a shared image associated with the update time. The partial image log information is a partial image and its position information associated with the update time. While the conference is in progress and image sharing is performed, the whole image log information and partial image log information from the start point of image sharing to the present point are stored in the log storage unit 150.

Note that the update time at which the shared image is updated may be determined by the time at which the image acquiring unit 130 has acquired the whole image or partial image, the time at which the whole image or partial image is generated, the time at which the whole image or partial image is stored in the log storage unit 150, or the time at which the whole image or partial image is transmitted to the information terminals 200a to 200d. That is, the acquisition time at which the whole image or partial image is acquired need only be the time of a point in a series of processes of displaying the image on the displays of the conference server 100 and information terminals 200a to 200d.

The operation information processor 180 processes information of an operation performed by the user of each of the information terminals 200a to 200d. For example, when receiving mouse click operation information from any of the information terminals 200a to 200d, the operation information processor 180 determines whether the mouse click position exists on the seek bar 11 of the GUI image 10. If the mouse click position does not exist on the seek bar 11 of the GUI image 10, the operation information processor 180 discards the mouse clock operation information. If the mouse click position exists on the seek bar 11 of the GUI image 10, the operation information processor 180 determines the time designated by the mouse click position on the seek bar 11.

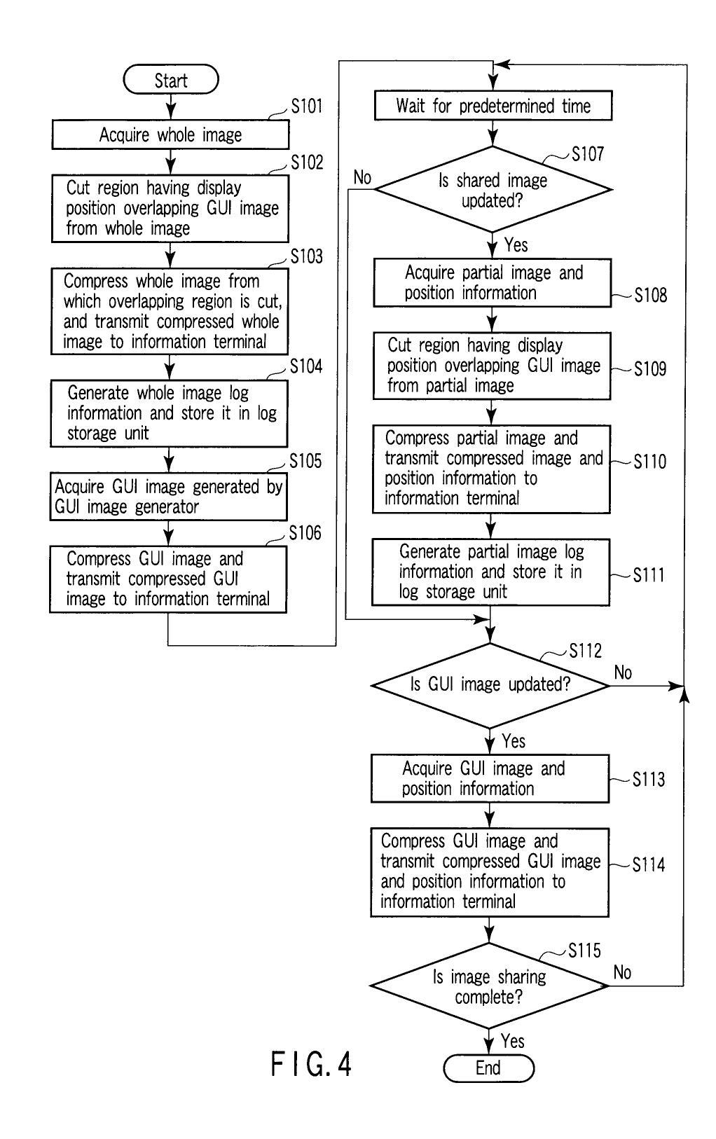

FIG. 4 is a flowchart showing the operation of the conference server 100 according to the first embodiment when performing image sharing between the conference server 100 and information terminals 200a to 200d.

First, image sharing is started between the conference server 100 and information terminals 200a to 200d. The image generator 110 writes a generated whole image in the display frame buffer. Then, the image acquiring unit 130 acquires the whole image written in the display frame buffer by the image generator 110 by hooking the whole image (step S101).

Subsequently, the image acquiring unit 130 cuts, from the whole image, a region where a region for displaying the acquired whole image and a region for displaying the GUI image 10 overlaps each other (step S102). The image acquiring unit 130 generates position information indicating a region for displaying the partially cut whole image.

The compressor 140 compresses the whole image from which the overlapping region of the display regions is cut. The communication unit 170 transmits the compressed whole image and the position information of the whole image to the information terminals 200a to 200d (step S103).

The image acquiring unit 130 stores the partially cut whole image and the acquisition time of the whole image as whole image log information in the log storage unit 150 (step S104).

The image acquiring unit 130 then receives the GUI image 10 generated by the GUI image generator 120 and position information indicating a region for displaying the GUI image 10 (step S105).

The compressor 140 compresses the GUI image 10 acquired by the image acquiring unit 130. The communication unit 170 transmits the compressed GUI image 10 and the position information of the GUI image 10 as GUI image information to the information terminals 200a to 200d (step S106).

After that, the conference server 100 waits for a predetermined time.

Then, the image acquiring unit 130 checks whether the image generator 110 has generated a new partial image since the whole image or partial image is transmitted last (step S107).

If the image generator 110 has not generated any new partial image (NO in step S107), the image acquiring unit 130 then checks whether the GUI image generator 120 has generated a new GUI image 10 (step S112).

On the other hand, if the image generator 110 has generated a new partial image (YES in step S107), the image acquiring unit 130 acquires the partial image and its position information from the image generator 110 (step S108).

If a region for displaying the acquired partial image and a region for displaying the GUI image 10 overlaps each other, the image acquiring unit 130 cuts the overlapping region from the partial image (step S109). When partially cutting the partial image, the image acquiring unit 130 generates new position information indicating a region for displaying the partially cut partial image.

Subsequently, the compressor 140 compresses the partial image. Note that if the partial image is partially cut by the image acquiring unit 130, the compressor 140 compresses the partially cut partial image. The communication unit 170 transmits the compressed partial image and the position information of the partial image to the information terminals 200a to 200d (step S110).

The image acquiring unit 130 associates the compressed partial image with the acquisition time at which the partial image is acquired, and stores the result as partial image log information in the log storage unit 150 (step S111).

The image acquiring unit 130 then checks whether the GUI image generator 120 has generated a new GUI image 10 since the GUI image 10 is transmitted last (step S112).

If the GUI image generator 120 has not generated any new GUI image 10 (NO in step S112), the conference server 100 waits for a predetermined time again. After waiting for the predetermined time, the conference server 100 repeats the processes in steps S107 to S111.

On the other hand, if the GUI image generator 120 has generated a new GUI image 10 (YES in step S112), the image acquiring unit 130 acquires the new GUI image 10 generated by the GUI image generator 120 and position information indicating a region for displaying the GUI image 10 (step S113).

The compressor 140 compresses the newly acquired GUI image 10 by coding. The communication unit 170 transmits the compressed GUI image 10 and the position information of the GUI image 10 as GUI image information to the information terminals 200a to 200d (step S114).

If image sharing between the conference server 100 and information terminals 200a to 200d is not complete (NO in step S115), the conference server 100 waits for a predetermined time again. After waiting for the predetermined time, the conference server 100 repeats the processes in steps S107 to S114.

On the other hand, if image sharing between the conference server 100 and information terminals 200a to 200d is complete (YES in step S115), the conference server 100 terminates the operation.

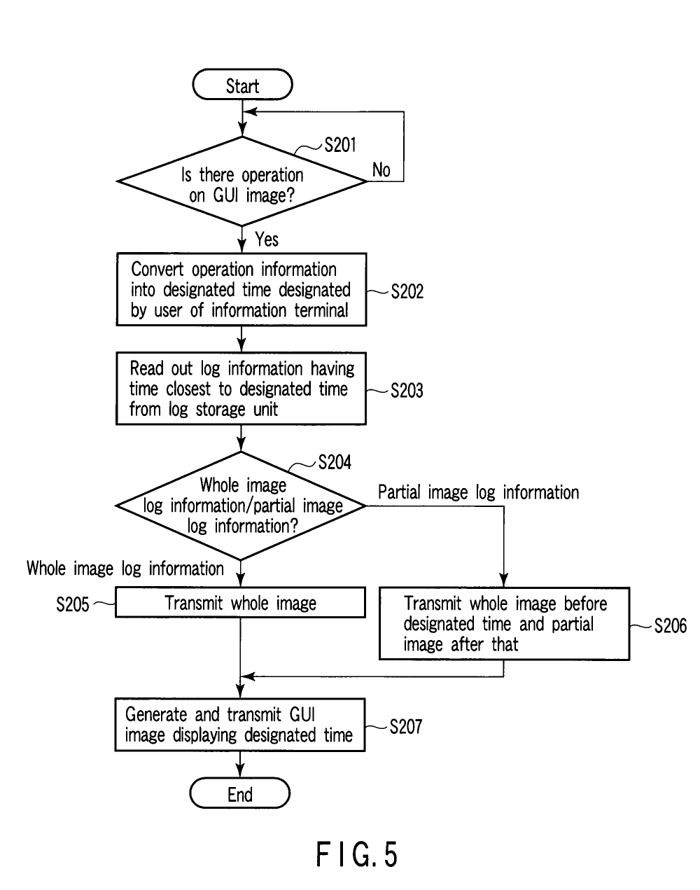

FIG. 5 is a flowchart showing the operation of the conference server 100 according to the first embodiment when transmitting, to the information terminals 200a to 200d, a past image shared by the conference server 100 and information terminals 200a to 200d. Note that a user A is operating the information terminal 200a.

First, the user A operates the information terminal 200a to perform a mouse click on the seek bar 11 of the GUI image 10. The information terminal 200a transmits, to the conference server 100, information concerning the user's operation, i.e., operation information indicating the mouse click position on the screen.

Then, the communication unit 170 of the conference server 100 receives the operation information. On the basis of the operation information received by the communication unit 170, the operation information processor 180 of the conference server 100 determines whether the operation is performed on the GUI image 10 (step S201).

If it is determined that the operation is not performed on the GUI image 10 (NO in step S201), e.g., if a mouse click or the like is performed in a region where the GUI image 10 is not displayed, the operation information processor 180 discards the received operation information, and waits until new operation information is received.

On the other hand, if it is determined that the operation is performed on the GUI image 10 (YES in step S201), the operation information processor 180 converts the received operation information into time (to be called designated time hereinafter) designated by the user having performed the operation on the GUI image 10 (step S202). For example, the operation information processor 180 converts the operation information into time designated by the user having performed the mouse click operation, in accordance with the mouse click position on the seek bar 11 of the GUI image 10. The operation information processor 180 transmits the designated time converted from the operation information to the log acquiring unit 160 and GUI image generator 120.

The log acquiring unit 160 reads out whole image log information or partial image log information stored in the log storage unit 150 in association with the time closest to the designated time received from the operation information processor 180 (step S203). Note that the log acquiring unit 160 may also read out whole image log information or partial image log information stored in the log storage unit 150 in association with the latest time before the designated time received from the operation information processor 180.

If the log acquiring unit 160 reads out whole image log information (whole image log information in step S204), the log acquiring unit 160 transmits the compressed whole image contained in the readout whole image log information to the information terminal 200a via the communication unit 170 (step S205).

On the other hand, if the log acquiring unit 160 reads out partial image log information (partial image log information in step S204), the log acquiring unit 160 determines an image to be transmitted to the information terminal 200a via the communication unit 170 as follows, and transmits the image.

The log acquiring unit 160 reads out the latest whole image log information from whole image log information having times before the designated time received from the operation information processor 180. The log acquiring unit 160 reads out all partial image log information having times after the time of the readout latest whole image log information and before the designated time. The log acquiring unit 160 transmits whole images contained in the readout whole image log information and partial images contained in the readout partial image log information to the information terminal 200a via the communication unit 170 in the order of the times of these pieces of log information (step S206).

Then, the GUI image generator 120 generates a GUI image 10 indicating the designated time received from the operation information processor 180. The image acquiring unit 130 acquires the GUI image 10 generated by the GUI image generator 120, and position information indicating the display position of the GUI image 10. The communication unit 170 transmits the GUI image 10 compressed by the compressor 140 and the position information of the GUI image 10 to the information terminal 200a (step S207).

In the operation of the conference system 1 according to the first embodiment shown in FIG. 4, the conference server 100 and information terminals 200a to 200d share an image, and the shared image is stored as log information. In the explanation of FIG. 4, the image generator 110 initially generates a whole image, and generates partial images after that.

The image generator 110 can also generate a whole image instead of a partial image if predetermined conditions are met. When the conference server 100 individually transmits a past shared image corresponding to the designated time to the information terminals, i.e., when the conference server 100 transmits the latest whole image before the designated time and all partial images after that, the number of partial images which the conference server 100 transmits to the information terminals can be reduced by storing whole image log information having the whole image in the log storage unit 150.

Two cases where the image generator 110 generates a whole image rather than a partial image will be explained below. Note that cases where the image generator 110 generates a whole image are not limited to the following two cases.

In the first case, the image generator 110 generates a whole image instead of a partial image if the image generator 110 does not generate any partial image or whole image, i.e., if the shared image displayed on the displays of the conference server 100 and information terminals 200a to 200d is not updated. Thus, the image generator 110 generates a whole image only when the shared image displayed on the displays of the conference server 100 and information terminals 200a to 200d is not updated. This makes it possible to prevent the increase in delay time in the shared image updating process.

In the second case, the image generator 110 generates a whole image rather than a partial image if the volume of partial image log information stored in the log storage unit 150 upon storing whole image log information last is equal to or larger than a threshold value. When the image generator 110 thus generates a whole image if the volume of partial image log information stored in the log storage unit 150 upon storing whole image log information last is equal to or larger than the threshold value, the number of partial images to be transmitted can be decreased to about the threshold value when the conference server 100 individually transmits past shared images to the information terminals. Note that when the conference server 100 individually transmits past shared images to the information terminals, the transmission delay can be decreased by setting a small threshold value to be used to determine whether the image generator 110 generates not a partial image but a whole image.

In the above description, the image generator 110 generates a whole image, and the log storage unit 150 stores whole image log information having the generated whole image. However, the log acquiring unit 160 can form a whole image by using the latest whole image log information of whole image log information stored in the log storage unit 150, and partial image log information having time after the time of the latest whole image log information and before the present time. That is, the log acquiring unit 160 can form a new whole image at the present time by expanding a compressed whole image contained in whole image log information and compressed partial images contained in partial image log information, and overwriting the partial images on the whole image in sequence of time.

If an update region of a partial image contained in certain partial image log information includes an update region of a partial image contained in partial image log information before the certain partial image log information, the log acquiring unit 160 can omit processes for the partial image contained in the partial image log information before the certain partial image log information.

In addition, if the total sum of update regions of a plurality of pieces of partial image log information stored in the log storage unit 150 is equivalent to the whole shared image, if time differences contained in the plurality of pieces of partial image log information are smaller than a predetermined value, and if the storage volume of the plurality of pieces of partial image log information is smaller than a predetermined value, the log acquiring unit 160 can regard these pieces of partial image log information as whole image log information.

Furthermore, if the generation frequency of partial images generated by the image generator 110 is high, or if the increase rate of the total storage volume of whole image log information and partial image log information stored in the log storage unit 150 decreases, the log acquiring unit 160 does not generate any new whole image by using the whole image log information and partial image log information stored in the log storage unit 150. That is, the log acquiring unit 160 forms a new whole image by using whole image log information and partial image log information stored in the log storage unit 150 after the generation frequency of partial images generated by the image generator 110 has decreased, or after the increase rate of the total storage volume of the whole image log information and partial image log information stored in the log storage unit 150 has decreased.

This makes it possible to prevent a large amount of partial image log information from being stored in the log storage unit 150 immediately after whole image log information formed by the log acquiring unit 160 is stored in the log storage unit 150. Accordingly, the number of partial images which the image server transmits to the information terminals can be reduced when the conference server 100 individually transmits a past shared image corresponding to the designated time to the information terminals, i.e., when the conference server 100 transmits the latest whole image before the designated time and all partial images after that.

In the conference system 1 according to the first embodiment as described above, participants of a conference can individually watch not only a shared image currently being displayed but also past shared images displayed during the conference on the displays of the information terminals used by these participants without holding any special function in these information terminals.

Also, since the information terminals need not hold any special function, no application program need be installed in the information terminals in order to allow the conference server and information terminals to share images. This makes it possible to reduce the processing load on the information terminals.

Note that in the above embodiment, a whole image is acquired from the image generator 110, the GUI image 10 is acquired from the GUI image generator 120, and a region for displaying the acquired whole image and a region for displaying the GUI image 10 overlaps each other is cut from the whole image.

The image acquiring unit 130, however, may also synthesize the acquired whole image and GUI image 10. For example, the image acquiring unit 130 can overwrite the display region of the GUI image 10 in the whole image by the GUI image 10. The image acquiring unit 130 can also synthesize a semitransparent GUI image 10 with the whole image. Note that the semitransparent GUI image 10 is an image in which a whole image or a whitened whole image is displayed in addition to the contours of the seek bar 11 and slider 12. The semitransparent GUI image 10 need only be an image in which an image deriving from a whole image is displayed in the display region of the GUI image 10 such that the contours of the seek bar 11 and slider 12 are clearly seen.

Note that in the above embodiment, if it is determined that the operation information received from the information terminal 200a does not indicate any operation on the GUI image 10 (NO in step S201 of FIG. 5), the operation information processor 180 discards the received operation information.

The operation information processor 180, however, can regard the received operation information as an operation not on the GUI image 10, but on a shared image (e.g., a conference document or presentation material) shared by the conference server 100 and information terminals 200a to 200d.

For example, when a conference document is displayed as a shared image on the displays of the conference server 100 and information terminals 200a to 200d and operation information received from an information terminal indicates not an operation on the GUI image 10 but an operation on the shared image (conference document), the operation information processor 180 can regard this operation as an operation of updating the conference document.

In this manner, not only the user operating the conference server 100 but also each participant of the conference can perform, e.g., updating of a shared image by operating his or her information terminal.

The above embodiment has been explained by taking, as an example, the case where the conference server 100 transmits the whole image or partial image stored in the log storage unit 150 in accordance with the time (designated time) designated by the user A of the information terminal 200a.

The conference server 100, however, can display, on the display of the information terminal 200a, a past moving image displayed on the displays of the conference server 100 and information terminals 200a to 200d after the designated time, by continuously transmitting a shared image corresponding to the designated time and shared images having times after the designated time in sequence of time. Two methods by which the conference server 100 displays a past moving image made up of past shared images on the display of the information terminal 200a will be explained below.

### (First Method)

First, as shown in steps S201 to S207 of FIG. 5, the conference server 100 transmits a past shared image shared by the conference server 100 and information terminals 200a to 200d to the information terminal 200a. That is, the conference server 100 converts GUI image operation information received from the information terminal 200a into designated time, and transmits a shared image corresponding to the designated time to the information terminal 200a.

Then, the log acquiring unit 160 specifies, from whole images or partial images forming the shared image corresponding to the designated time, whole image log information or partial image log information associated with the latest time when stored as whole image log information or partial image log information in the log storage unit 150.

Subsequently, the log acquiring unit 160 newly reads out whole image log information or partial image log information stored as log information in the log storage unit 150 next to the specified whole image log information or partial image log information.

The log acquiring unit 160 then calculates a difference between the designated time designated by the user by operating the GUI image and the time of the newly readout whole image log information or partial image log information, and waits for the calculated time.

After the log acquiring unit 160 waits for the calculated time, the communication unit 170 transmits the whole image log information or partial image log information read out by the log acquiring unit 160 to the information terminal 200a.

In addition, the log acquiring unit 160 reads out whole image log information or partial image log information stored as log information in the log storage unit 150 next to the whole image log information or partial image log information newly read out from the log storage unit 150, and repeats the above processing.

As described above, the conference server 100 transmits a past shared image corresponding to the designated time, and transmits in time sequence whole image log information or partial image log information stored in the log storage unit 150 in association with times after the designated time. By repeating this processing, a moving image made up of past shared images displayed on the displays of the conference server 100 and information terminals 200a to 200d can be individually displayed on each information terminal (e.g., the information terminal 200a).

In the above operation, when the conference server 100 having transmitted a past shared image to the information terminal 200a transmits a new past shared image to the information terminal 200a, the log acquiring unit 160 calculates a difference between the designated time designated by the user by operating the GUI image and the time of newly readout whole image log information or partial image log information, and waits for the calculated time.

The waiting time of the log acquiring unit 160, however, can also be ½, ⅓, . . . , the calculated time.

In this case, the conference server 100 can display a moving image made up of past shared images at double speed, triple speed, . . . , on the display of the information terminal 200a. Accordingly, each participant of the conference can rapidly recognize the past contents of the conference.

In the above description, it is assumed that the time required for the communication unit 170 to transmit a past shared image to the information terminal 200a is negligibly short. However, if the time required for the communication unit 170 to transmit a past shared image to the information terminal 200a is long, the waiting time of the log acquiring unit 160 is set short by the time required for the communication unit 170 to transmit a past shared image to the information terminal 200a.

### (Second Method)

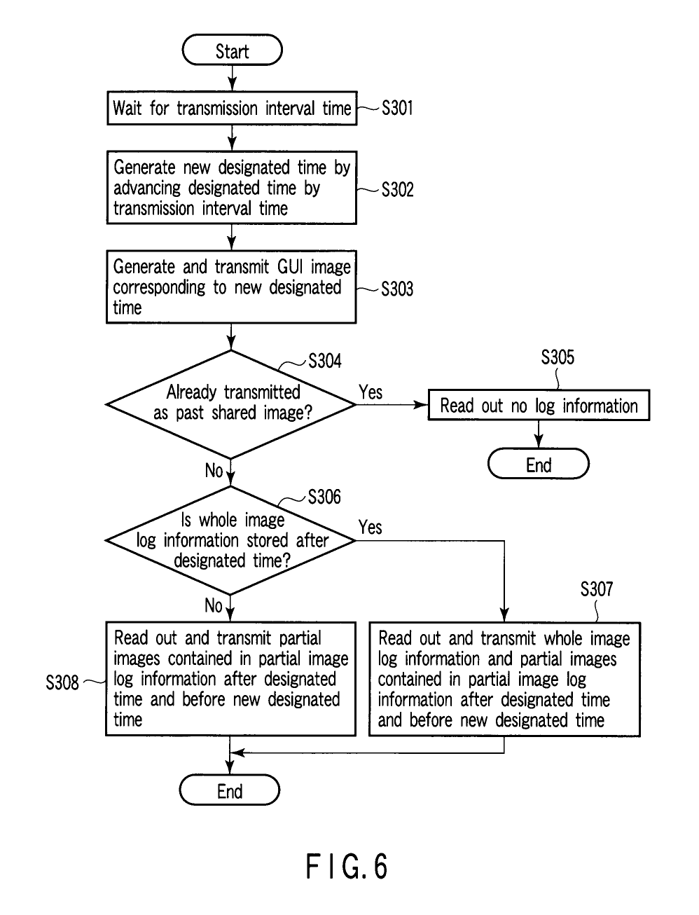

FIG. 6 is a flowchart showing the operation when the conference server 100 displays, on the display of the information terminal 200a, a past moving image displayed on the displays of the conference server 100 and information terminals 200a to 200d by continuously transmitting past shared images.

Note that in the following explanation, a time from the transmission of a certain past image to the transmission of the next past image when the conference server 100 continuously transmits past shared images to each information terminal will be called a transmission interval time.

The transmission interval time is determined in accordance with the frame rate of a past moving image to be displayed on the display of each information terminal. For example, when the frame rate of a past moving image to be displayed on the display of the information terminal 200a is 30 fps (frame per second), the transmission interval time is set at 1/30 sec as the reciprocal of the frame rate.

The transmission interval time is a time from the timing at which an image displayed on the display of each information terminal is updated to the timing at which the image is updated next. Therefore, the display of each information terminal operated by the user displays, for every transmission interval time, a past shared image shared by the conference server 100 and information terminals 200a to 200d. For this reason, the transmission interval time must be short to such an extent that the user can recognize the contents of the conference from the past shared images successively displayed on the display of the information terminal.

First, as shown in steps S210 to S207 of FIG. 5, the conference server 100 transmits a past shared image shared by the conference server 100 and information terminals 200a to 200d to the information terminal 200a. That is, the conference server 100 converts GUI image operation information received from the information terminal 200a into designated time, and transmits a shared image corresponding to the designated time to the information terminal 200a.

Then, the conference server 100 waits for the transmission interval time (step S301).

Subsequently, the operation information processor 180 generates a new designated time by advancing the designated time by the transmission interval time. The operation information processor 180 transmits the new designated time to the GUI image generator 120 and log acquiring unit 160 (step S302).

The GUI image generator 120 receives the new designated time, and generates a GUI image indicating the new designated time. The compressor 140 compresses the GUI image generated by the GUI image generator 120, and the communication unit 170 transmits the compressed GUI image to the information terminal 200a (step S303).

The log acquiring unit 160 receives the new designated time, and determines whether an image contained in whole image log information or partial image log information stored in the log storage unit 150 in association with time closest to the new designated time has already been transmitted as a past shared image to the information terminal 200a (step S304). That is, the log acquiring unit 160 determines whether an image contained in whole image log information or partial image log information corresponding to the new designated time has already been transmitted to the information terminal 200a as a shared image corresponding to designated time earlier than the new designated time by the transmission interval time.

If it is determined that the image has already been transmitted as a shared image corresponding to the designated time to the information terminal 200a (“YES” in step S304), the log acquiring unit 160 does not read out any log information from the log storage unit 150 (step S305).

On the other hand, if it is determined that the image has not been transmitted yet as a shared image corresponding to the designated time to the information terminal 200a (“NO” in step S304), the log acquiring unit 160 determines whether whole image log information exists in log information associated with times after a designated time earlier than the new designated time by the transmission interval time and before the new designated time (step S306).

If it is determined that whole image log information exists (“YES” in step S306), the log acquiring unit 160 reads out the whole image log information, and partial image log information associated with times after the time associated with the whole image log information and before the new designated time. The communication unit 170 transmits whole images contained in the whole image log information read out by the log acquiring unit 160 and partial images contained in the partial image log information read out by the log acquiring unit 160 to the information terminal 200a in sequence of time (step S307).

If it is determined that no whole image log information exists (“NO” in step S306), the log acquiring unit 160 reads out partial image log information associated with times after a designated time earlier than the new designated time by the transmission interval time and before the new designated time. The communication unit 170 transmits partial images contained in the partial image log information read out by the log acquiring unit 160 to the information terminal 200a in time sequence (step S308).

Furthermore, the operation information processor 180 repeats the above processing again (steps S301 to S308 in FIG. 6).

As described above, the conference server 100 transmits a past shared image corresponding to the designated time, and then transmits a past shared image corresponding to a new designated time obtained by advancing the former designated time by the transmission interval time. By repeating this processing, a moving image made up of past shared images displayed on the displays of the conference server 100 and information terminals 200a to 200d can be individually displayed on each information terminal.

Also, in the above operation, when the conference server 100 having transmitted a past shared image to the information terminal 200a transmits a new past shared image to the information terminal 200a next (step S301 in FIG. 6), the conference server 100 waits for the transmission interval time.

The waiting time of the conference server 100, however, can also be ½, ⅓, . . . , the transmission interval time.

In this case, the conference server 100 can display a moving image made up of past shared images at double speed, triple speed, . . . , on the display of the information terminal 200a. Accordingly, each participant of the conference can rapidly recognize the past contents of the conference.

In the above description, it is assumed that the time required for the communication unit 170 to transmit a past shared image to the information terminal 200a is negligibly short. However, if the time required for the communication unit 170 to transmit a past shared image to the information terminal 200a is long, the waiting time of the log acquiring unit 160 is set short by the time required for the communication unit 170 to transmit a past shared image to the information terminal 200a.

Note that the conference server 100 can also be implemented by using a general-purpose computer as the basic hardware. That is, the image generator 110, GUI image generator 120, image acquiring unit 130, compressor 140, log acquiring unit 160, communication unit 170, and operation information processor 180 can be implemented by allowing a processor of the computer to execute programs. In this case, the conference server 100 may be implemented by preinstalling the programs in the computer, or by distributing the programs by storing them in a storage medium such as a CD-ROM or transmitting them across a network, and appropriately installing the programs in the computer. Also, the log storage unit 150 can be implemented by properly using a built-in or external memory or hard disk of the computer, or a storage medium such as a CD-R, CD-RW, DVD-RAM, or DVD-R.

### Second Embodiment

In the first embodiment, an image displayed on the displays of the information terminals 200a to 200d is either a present shared image currently being shared by the conference server 100 and information terminals 200a to 200d, or a past shared image shared by the conference server 100 and information terminals 200a to 200d. However, it is desirable for a user as a participant of a conference to be able to simultaneously watch a present shared image and past shared image.

In a conference system according to the second embodiment, therefore, an image acquiring unit 1130 further has a function of cutting a region for displaying a GUI image 10 and a region for displaying a past shared image from a whole image or partial image acquired from an image generator 110. Also, a log acquiring unit 1160 further has a function of expanding or reducing a compressed whole image contained in whole image log information read out from a log storage unit 150, or a compressed partial image contained in partial image log information.

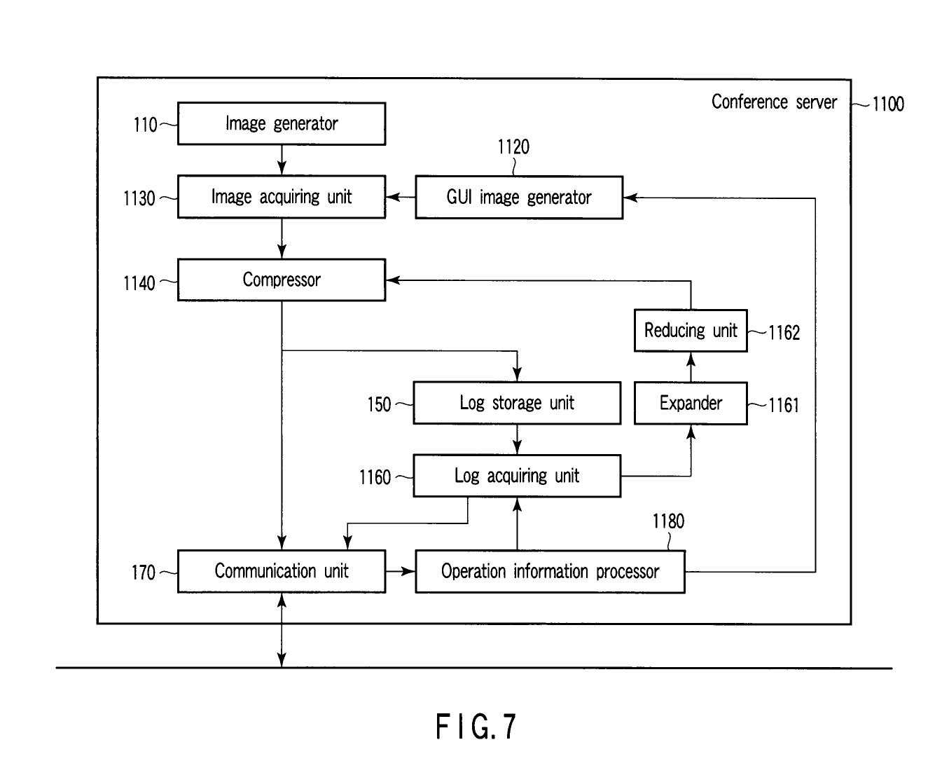

FIG. 7 is a block diagram showing the arrangement of a conference server 1100 according to the second embodiment. The conference server 1100 according to the second embodiment comprises the image generator 110, a GUI image generator 1120, the image acquiring unit 1130, a compressor 1140, the log storage unit 150, the log acquiring unit 1160, a communication unit 170, an operation information processor 1180, an expander 1161, and a reducing unit 1162. Note that an explanation of the same units (the image generator 110, log storage unit 150, and communication unit 170) of the conference server according to the second embodiment as those of the conference server 100 according to the first embodiment and information terminals 200a to 200d will not be repeated.

The GUI image generator 1120 generates a GUI image 1010 having an interface for designating time, an interface for displaying the designated time, and an interface for designating whether to display only a present shared image, only a past shared image, or both present and past shared images.

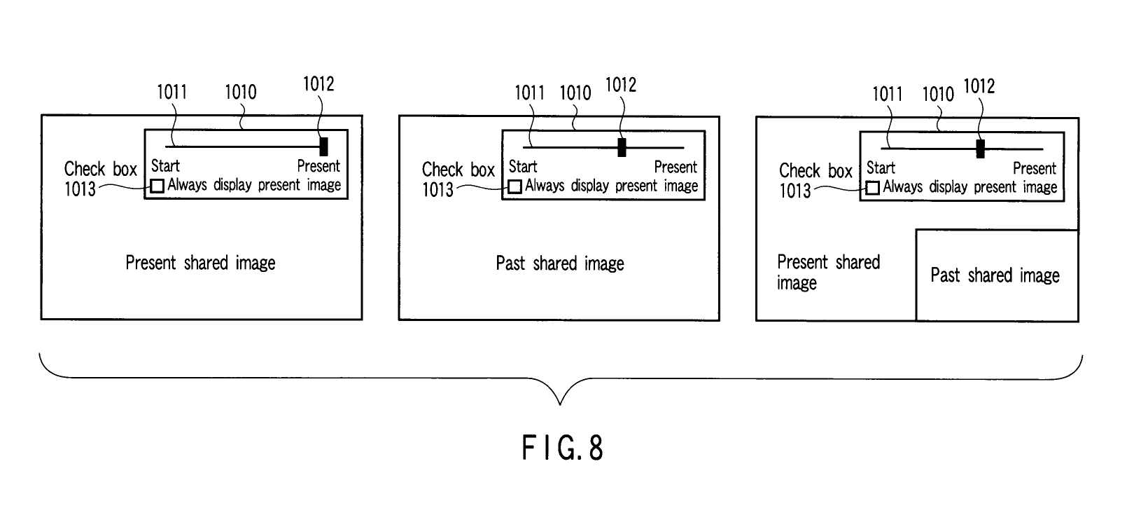

FIG. 8 is a view showing an example of the GUI image 1010.

The user designates time by using a seek bar 1011 of the GUI image 1010, and visually recognizes the designated time in accordance with the position of a slider 1012 on the seek bar 1011. The user allows the whole screen to display a present shared image by designating the present time by the slider 1012. The user allows the whole screen to display a past shared image by designating the past time by the slider 1012, and keeping a check box 1013 of “always display present image” unchecked. The user allows the whole screen to display a present shared image and allows a partial region on the screen to display a past shared image by designating the past time by the slider 1012, and checking the check box 1013 of “always display present image”.

The operation information processor 1180 processes information of an operation performed by the user on each of the information terminals 200a to 200d. For example, when receiving mouse click operation information, the operation information processor 1180 determines whether the mouse click position exists on the seek bar 1011 of the GUI image 1010, or on the check box 1013 of “always display present image”.

If the mouse click position exists on the seek bar 1011 of the GUI image 1010, the operation information processor 1180 determines the time designated by the mouse click position on the seek bar 1011.

If the mouse click position exists on the check box 1013 of “always display present image” of the GUI image 1010, the operation information processor 1180 determines that the check box 1013 of “always display present image” is made unchecked if there is a check in the box, and that the check box 1013 of “always display present image” is checked if there is no check in the box.

Note that if the mouse click position exists on neither the seek bar 1011 of the GUI image 1010 nor the check box 1013 of “always display present image”, the operation information processor 1180 discards the operation information received from the corresponding one of the information terminals 200a to 200d via the communication unit 170.

If a region for displaying a whole image or partial image acquired from the image generator 110 overlaps a region for displaying the GUI image 1010 and a region for displaying a past shared image, the image acquiring unit 1130 cuts the overlapping region from the whole image or partial image. Note that the image acquiring unit 130 receives, from the operation information processor 1180, information indicating whether the check box 1013 of “always display present image” is checked, and stores position information of a region for displaying a past shared image.

The operation of the conference server according to the second embodiment when transmitting both present and past shared images to the information terminals 200a to 200d will be explained below. Note that an explanation of the same operation as that of the conference server 100 according to the first embodiment will not be repeated.

First, the operation information processor 1180 converts operation information received from any of the information terminals 200a to 200d into past time (to be referred to as designated time hereinafter) designated by the slider 1012, and information (to be referred to as check information hereinafter) indicating that the check box 1013 of “always display present image” is checked. The operation information processor 1180 transmits the designated time and check information to the GUI image generator 1120, and the designated time to the log acquiring unit 1160.

In accordance with the received designated time and check information, the GUI image generator 1120 generates a new GUI image 1010 indicating the designated time, and also indicating that the check box 1013 of “always display present image” is checked.

The log acquiring unit 1160 reads out whole image log information or partial image log information on the basis of the received designated time, and transmits those compressed whole images and partial images for forming past shared images, which are respectively contained in whole image log information and partial image log information stored in the log storage unit 150, to the expander 1161 in sequence of time.

Then, the expander 1161 expands the compressed whole images and partial images received in sequence of time, and superposes the expanded images in sequence of time, thereby generating past shared images.

Subsequently, the reducing unit 1162 reduces the past shared images in accordance with a region for displaying a past shared image on the corresponding one of the information terminals 200a to 200d. The compressor 1140 compresses the reduced past shared images by coding, and the communication unit 170 transmits the compressed images to the corresponding one of the information terminals 200a to 200d.

In the conference system according to the second embodiment as described above, each participant of the conference can individually watch a shared image currently being displayed and a past shared image displayed during the conference at the same time on the display of the information terminal used by the participant without holding any special function in the information terminals 200a to 200d used by the participants of the conference.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A server apparatus which transmits image information to an information terminal and displays the image information on a screen of the information terminal, the apparatus comprising:
a first generating device configured to generate whole image information for updating the whole of the image information or partial image information for updating a part of the image information;
a second generating device configured to generate GUI (Graphical User Interface) image information for designating time;
a compressing device configured to compress the whole image information or the partial image information and the GUI image information by coding;
a storage device configured to store the compressed whole image information or the compressed partial image information in association with update time of the image information;
a transmitting device configured to transmit the compressed whole image information or the compressed partial image information and the compressed GUI image information to the information terminal;
a receiving device configured to receive, from the information terminal, operation information indicating a user's operation for designating time for the GUI image information displayed on the screen of the information terminal;
a converting device configured to convert the operation information into designated time designated by the user; and
a read device configured to read out the whole image information or the partial image information from the storage device in accordance with the designated time,
wherein when the whole image information is read out, the transmitting device transmits the readout whole image information to the information terminal, and
when the partial image information is read out, the transmitting device transmits, to the information terminal, latest whole image information of whole image information stored in the storage device in association with times before the designated time, and partial image information stored in the storage device in association with times after the time associated with the whole image information and before the designated time.

2. The apparatus according to claim 1, wherein
the read device further reads out whole image information or partial image information stored in the storage device in association with times after the designated time, and
the transmitting device transmits the whole image information or the partial image information read out by the read device to the information terminal in a time sequence.

3. The apparatus according to claim 1, which further comprises a forming device configured to, if the read device reads out the partial image information, form whole image information corresponding to the designated time from latest whole image information of whole image information stored in the storage device in association with times before the designated time, and from partial image information stored in the storage device in association with times after the time associated with the whole image information and before the designated time, and
in which the transmitting device transmits the formed whole image information to the information terminal.

4. The apparatus according to any one of claims 1 to 3, which further comprises a cutting device configured to, if a region in which the whole image information or the partial image information is displayed on the screen of the information terminal and a region in which the GUI image information is displayed on the screen of the information terminal overlaps each other, cut the overlapping region from the whole image information or the partial image information, and
in which the transmitting device transmits, to the information terminal, the whole image information or the partial image information from which the overlapping region is cut by the cutting device.

5. The apparatus according to any one of claims 1 to 3, which further comprises:
a cutting device configured to, if a region in which the whole image information or the partial image information is displayed on the screen of the information terminal and a region in which the GUI image information is displayed on the screen of the information terminal overlaps each other, cut the overlapping region from the whole image information or the partial image information; and
a fitting device configured to fit the GUI image information in the whole image information or the partial image information from which the overlapping region is cut by the cutting device, thereby forming new whole image information or new partial image information, and
in which the transmitting device transmits, to the information terminal, the image information in which the GUI image information is fitted in the whole image information or the partial image information.

6. The apparatus according to any one of claims 1 to 3, which further comprises a synthesizing device configured to generate new whole image information or new partial image information by synthesizing the whole image information or the partial image information and the GUI image information, and
in which the transmitting device transmits the new whole image information or the new partial image information generated by the synthesizing device to the information terminal.

7. The apparatus according to any one of claims 1 to 3, wherein the transmitting device transmits the whole image information or the partial image information generated by the first generating device and compressed by coding by the compressing device, and simultaneously transmits, to the information terminal, the whole image information or the whole image information and the partial image information which correspond to the designated time and are stored in the storage device.

8. The apparatus according to claim 7, further comprising a second cutting device configured to, if a region in which the whole image information, or the whole image information and the partial image information, to be simultaneously transmitted to the information terminal by the transmitting device, and to be transmitted without being stored in the storage device are displayed on the screen of the information terminal overlaps a region in which image information to be transmitted in accordance with the designated time after being stored in the storage device is displayed on the screen of the information terminal, cut the overlapping region from the image information to be transmitted without being stored in the storage device.

9. The apparatus according to claim 8, which further comprises:
a read device configured to read out the whole image information or the whole image information and the partial image information which correspond to the designated time and are stored in the storage device;
an expanding device configured to expand the readout whole image information or the readout whole image information and the readout partial image information; and
a reducing device configured to reduce the expanded whole image information or the expanded whole image information and the expanded partial image information in accordance with a display region to be displayed on the information terminal, and
in which the compressing device compresses the whole image information or the whole image information and the partial image information which are reduced by the reducing device, and
the transmitting device transmits the whole image information or the whole image information and the partial image information which are compressed by the compressing device to the information terminal.

10. The apparatus according to claim 1, wherein the first generating device generates the whole image information if a total size of partial image information stored in the storage device in association with times after the time associated with latest whole image information of whole image information stored in the storage device and before the present time has exceeded a threshold value.

11. The apparatus according to claim 10, wherein if the total size of the partial image information stored in the storage device has exceeded the threshold value and an increase rate of the partial image information stored in the storage device has not decreased, the first generating device generates the whole image information, and, if the increase ratio of the partial image information stored in the storage device has decreased, the first generating device waits until the increase rate stops decreasing or starts increasing, and generates the whole image information.

12. The apparatus according to claim 1, further comprising a regarding device configured to, if a region updated by a group of partial images in partial image information stored in the storage device in association with times after the time associated with latest whole image information of whole image information stored in the storage device and before the present time covers the whole of the image information, regard the group of partial images as whole image information.

13. The apparatus according to claim 1, wherein
the GUI image information has a display portion for displaying time,
when the receiving device receives the operation information and the converting device converts the operation information into the designated time, the second generating device generates new GUI image information having the display portion for displaying the designated time, and
the transmitting device transmits the new GUI image information to the information terminal.

14. The apparatus according to claim 1, wherein
the receiving device receives, from the information terminal, operation information indicating a user's operation on the image information displayed on the screen of the information terminal,
the converting device converts the operation information into update information for updating the image information, and
the first generating device generates whole image information for updating the whole of the image information, or partial image information for updating a part of the image information, in accordance with the update information converted by the converting device.

15. A control method of a server apparatus which transmits image information to an information terminal and displays the image information on a screen of the information terminal, the method comprising:
generating whole image information for updating the whole of the image information or partial image information for updating a part of the image information;
generating GUI image information for designating time;
compressing the whole image information or the partial image information and the GUI image information by coding;
storing, in a storage device, the compressed whole image information or the compressed partial image information in association with update time of the image information;
transmitting the compressed whole image information or the compressed partial image information and the compressed GUI image information to the information terminal;
receiving, from the information terminal, operation information indicating a user's operation for designating time for the GUI image information displayed on the screen of the information terminal;
converting the operation information into designated time designated by the user;
reading out the whole image information or the partial image information from the storage device in accordance with the designated time;
when the whole image information is read out, transmitting the readout whole image information to the information terminal; and
when the partial image information is read out, transmitting, to the information terminal, latest whole image information of whole image information stored in the storage device in association with times before the designated time, and partial image information stored in the storage device in association with times after the time associated with the whole image information and before the designated time.

16. A computer-readable recording medium recording a control program of a server apparatus which transmits image information to an information terminal and displays the image information on a screen of the information terminal, the medium comprising:
a function of generating whole image information for updating the whole of the image information or partial image information for updating a part of the image information;
a function of generating GUI image information for designating time;
a function of compressing the whole image information or the partial image information and the GUI image information by coding;
a function of storing, in a storage device, the compressed whole image information or the compressed partial image information in association with update time of the image information;
a function of transmitting the compressed whole image information or the compressed partial image information and the compressed GUI image information to the information terminal;
a function of receiving, from the information terminal, operation information indicating a user's operation for designating time for the GUI image information displayed on the screen of the information terminal;
a function of converting the operation information into designated time designated by the user;
a function of reading out the whole image information or the partial image information from the storage device in accordance with the designated time;
a function of, when the whole image information is read out, transmitting the readout whole image information to the information terminal; and
a function of, when the partial image information is read out, transmitting, to the information terminal, latest whole image information of whole image information stored in the storage device in association with times before the designated time, and partial image information stored in the storage device in association with times after the time associated with the whole image information and before the designated time.
